(19) United States
(12) Patent Application Publication
(10) Pub. No.: US 2005/0206697 A1
(43) Pub. Date: Sep. 22, 2005

(54) [INK CARTRIDGE]

(76) Inventors: Chee-Shuen Lee, Hsinchu City (TW); Cheng-Wei Hsu, Tai-Nan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/709,716

(22) Filed: May 24, 2004

(30) Foreign Application Priority Data
Mar. 19, 2004 (TW) 93107409

(51) Int. Cl. B41J 2/175

(52) U.S. Cl. 347/86

(57) ABSTRACT

An ink cartridge is provided. The ink cartridge includes a housing, an ink storage unit and an ink pipe. The ink storage unit is disposed inside a substantially sealed space of the housing and substantially airtightly contacts with the inner wall of the bottom of the housing to reduce the possibility of bubbles in the ink pipe or on the filter of the ink pipe. The ink storage unit is above the ink pipe and form a gap between the ink storage unit and the top of the ink pipe. A portion of the ink storage unit adjacent to the ink pipe may have a capillarity larger than the other portion of the ink storage unit so as to effectively introduce the ink toward the ink pipe and thereby the rate of ink usability can be enhanced and the ink residual in the ink storage unit can be reduced.

### CROSS REFERENCE TO RELATED APPLICATIONS

This application claims the priority benefit of Taiwan application serial no. 93107409, filed on Mar. 19, 2004.

### BACKGROUND OF INVENTION

1. Field of the Invention

This invention generally relates to an ink cartridge, and more particularly to an ink cartridge capable of enhancing the rate of ink usability and decreasing the possibility of blocking ink-feeding path by the bubble in the ink.

2. Description of Related Art

As the inkjet print technology progresses, the inkjet print technology has been widely applied in the office equipment having the printing function, such as the printer, copy machine and the fax machine. The inkjet print technology uses the high pressure generated by the inkjet head (inkjet chip) to push the ink so that the ink in the form of droplets can be jetted from the inkjet head onto the paper to form the ink spots. The ink spots on the surface of the paper thus form the texts or the pictures. For the purpose of continuously supplying the ink to the inkjet head, the traditional art uses the ink cartridge to store ink so that the ink cartridge can directly or indirectly supplied the ink to the inkjet head.

To prevent the ink from leaking from the ink cartridge, the porous material, such as sponge (foam) or fabric, is utilized to form an ink storage unit and is disposed inside the ink cartridge. The pores or cells in the porous material not only can store the ink, but also can absorb the ink, via the capillarity, to prevent the ink from leaking from the ink cartridge. For the purpose of reducing the residual ink in the ink storage unit, the U.S. Pat. No. 4,771,295 used the ink pipe to compressively contact the ink storage unit in order to increase the porous density inside a portion of the ink storage unit above the ink pipe. Hence, the portion of the ink storage unit above the ink pipe has a larger capillarity so that the ink inside the other portion of the ink storage unit would flow toward the ink pipe.

However, in the U.S. Pat. No. 4,771,295, the ink pipe may compress the ink storage unit non-uniformly because of the non-uniformly external force applied to dispose the ink storage unit into the ink cartridge, or the ink pipe does not completely contact the ink storage unit. These may cause two problems:

1. When the portion of the ink storage unit above the ink pipe is over-compressed, the capillarity in that portion is too large that, when the ink cartridge has been used for a while (e.g., at the end period of the ink cartridge life), the ink cannot flow from the ink storage unit to the ink pipe, which causes too much ink residual in the ink storage unit.

2. When the porous material is used as the ink storage unit of a cartridge, there is usually an air vent on the top of the ink cartridge. When a portion of the ink pipe does not contact or does not completely contact the ink storage unit, the ink storage unit is not airtight with the ink pipe. Hence, when the air enters into the ink cartridge and forms air bubbles, the bubbles would be accumulated between the ink storage unit and the ink pipe, or within the ink pipe. The bubbles will block the ink pipe or the filter of the ink pipe so that the ink cannot flow into the ink pipe smoothly, and hence the ink cartridge cannot supply the ink smoothly.

### SUMMARY OF INVENTION

The present invention is directed to an ink cartridge capable of reducing the possibility of forming bubbles between the ink storage unit and the ink pipe, and/or preventing the bubbles from entering into the ink pipe during the ink supply process.

The present invention is directed to an ink cartridge capable of increasing the capillarity in some portion of the ink storage unit in order to enhance the rate of ink usability.

The present invention is also directed to an ink cartridge to resolve the problem of over residual ink in the ink storage unit due to the over compression of the ink storage unit by the ink pipe.

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

According to an embodiment of the present invention, the ink cartridge comprises a housing having a substantially sealed space, an ink pipe connected to the housing, and an ink storage unit disposed inside the sealed space that substantially airtightly contacts the inner wall of the bottom of the housing. The ink pipe is fluidly linked to the sealed space. The ink storage unit is positioned above the ink pipe and has a gap with the top of the ink pipe.

In an embodiment of the present invention, the porous material comprises, for example, foam or a sponge material or a fabric material. The ink pipe is, for example, extended into the substantially sealed space.

According to an embodiment of the present invention, the ink cartridge comprises a housing having a substantially sealed space, an ink pipe connected to the housing, and an ink storage unit disposed within the sealed space that substantially airtightly contacts the inner wall of the a bottom of the housing. The ink pipe is fluidly connected to the sealed space. The ink storage unit is positioned above the ink pipe and having a gap with the top of the ink pipe. A portion of the ink storage unit adjacent to the ink pipe has a capillarity larger than the other portion of the ink storage unit.

In an embodiment of the present invention, the porous material comprises, for example, foam or a sponge material or a fabric material. The ink storage unit may be fabricated to have non-uniform porous density by, for example, a foaming process or a heat pressing process, for example, to let a portion of the ink storage unit adjacent to the ink pipe have a larger porous density than the other portion of the ink storage unit.

Because the ink storage unit in the ink cartridge of an embodiment of the present invention substantially airtightly contacts the inner wall of the bottom of the housing, the present invention can reduce the possibility of forming bubbles between the ink storage unit and the ink pipe so as to prevent the bubbles from blocking the ink pipe or the filter of the ink pipe. According to another embodiment of the present invention, an ink storage unit with the non-uniform porous density is deposed in the sealed space of the housing so that the ink tends to flow toward the ink pipe. Hence, it can effectively introduce the ink to the ink pipe to enhance the rate of ink usability and/or to reduce the possibility of ink residual.

The above is a brief description of some deficiencies in the prior art and advantages of the present invention. Other features, advantages and embodiments of the invention will be apparent to those skilled in the art from the following description, accompanying drawings and appended claims.

### BRIEF DESCRIPTION OF DRAWINGS

FIG. 1 is a cross-sectional view of an ink cartridge in accordance with an embodiment of the present invention.

FIG. 2 is a cross-sectional view of an ink cartridge in accordance with another embodiment of the present invention.

FIGS. 3A and 3B are cross-sectional views of an ink cartridge in accordance with yet two other embodiments of the present invention respectively.

FIG. 4A is a cross-sectional view of an ink cartridge in accordance with yet another embodiment of the present invention.

FIG. 4B is a cross-sectional view of an ink cartridge in accordance with yet another embodiment of the present invention.

FIG. 5 is a cross-sectional view of an ink cartridge in accordance with yet another embodiment of the present invention.

### DETAILED DESCRIPTION

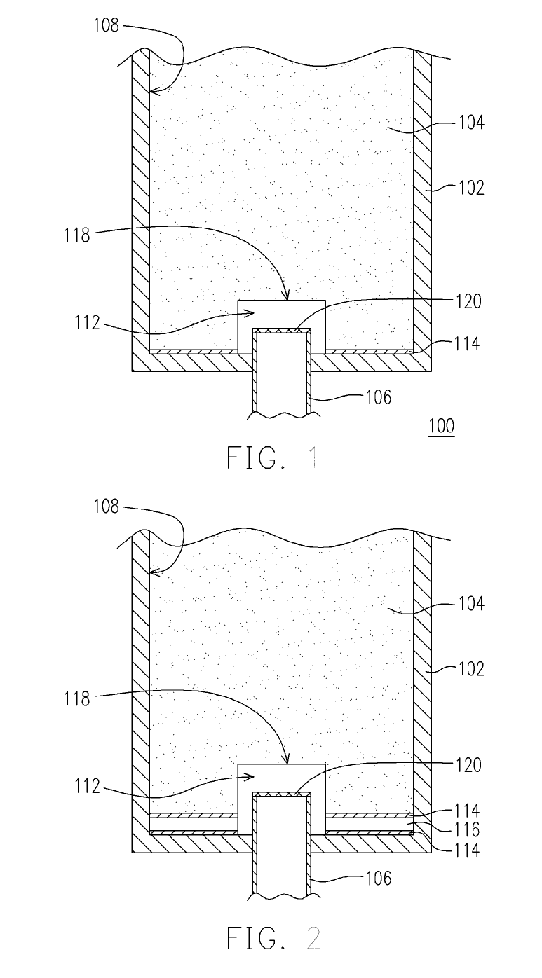

FIG. 1 is a cross-sectional view of an ink cartridge in accordance with an embodiment of the present invention. Referring to FIG. 1, the ink cartridge 100 comprises a housing 102, an ink storage unit 104 and an ink pipe 106. The housing 102 has a substantially sealed space 108 to accommodate the ink storage unit 104. The ink pipe 106 is connected to the housing 102 and is fluidly linked to the sealed space 108 to introduce the ink out of the ink cartridge 102 to an inkjet chip (not shown). The ink pipe 106, for example, has a filter 120 to filter the impurity of the ink. In this embodiment, the filter 120 is disposed at the top of the ink pipe 106. The ink storage unit 104 is made of a porous material. The porous material comprises, for example, foam or a sponge material or a fabric material, adapted for absorbing and storing the ink via the pores or cells of the porous material.

In addition, the housing 102 usually have an air vent (not shown), for example, on the top of the housing 102 to introduce the air into the sealed space 108. During the ink is output from the housing 102, the air can enter into the vent to balance the air pressure of the sealed space and the external environment so that the ink in the ink storage unit 104 can be continuously supplied to the inkjet chip via the ink pipe 106. Therefore, the term “substantial sealed space” or “sealed space” in the specification or claims does not mean that the space 108 cannot communicate with the outside. The ink storage unit 104 substantially airtightly contacts the inner wall of the bottom of the housing 102 to reduce the possibility of air entering into the ink pipe 106, and hence to reduce the possibility of air bubbles blocking the ink pipe 106 or the filter 120. Further, the ink storage unit 104 is located above the ink pipe 106 and there is a gap 112 formed between the ink storage unit 104 and the top of the ink pipe 106. To form the gap 112 between the ink storage unit 104 and the top of the ink pipe 106, an illustrative example of a cave 118 can be designed at the bottom of the ink storage unit 104 adjacent to the ink pipe 106. The gap 112 is capable of reducing the possibility of ink storage unit 104 being non-uniformly compressed by the ink pipe 106.

According to an embodiment of the present invention, the ink storage unit 104 can be adhered or welded to the inner wall of the bottom of the housing 102. According to an embodiment of the present invention, an adhesive layer 114 may be used to adhere the ink storage unit 104 onto the inner wall of the bottom of the housing 102. The adhesive layer 114, for example, can be a double-sided tape or other adhesive materials. If the ink storage unit 104 is welded onto the inner wall of the bottom of the housing 102, then adhesive layer 114 is unnecessary. In another embodiment of the present invention, the ink storage unit 104 is welded to the inner wall of the bottom of the housing 102 by using either heat sealing or ultrasound welding. It should be noted that it is not necessary to let the entire bottom of the ink storage unit 104 airtightly contacts the inner wall of the bottom of the housing 102. Only one part of the bottom of the ink storage unit 104 adhering or welding to the inner wall of the bottom of the housing 102 to establish an barrier of substantially preventing the air from entering into the ink pipe 106 is enough for this embodiment. Therefore, the meaning of the term “airtightly contacts an inner wall of a bottom of the housing” is not limited to “the entire bottom of the ink storage unit airtightly contacting an inner wall of a bottom of the housing” in this invention.

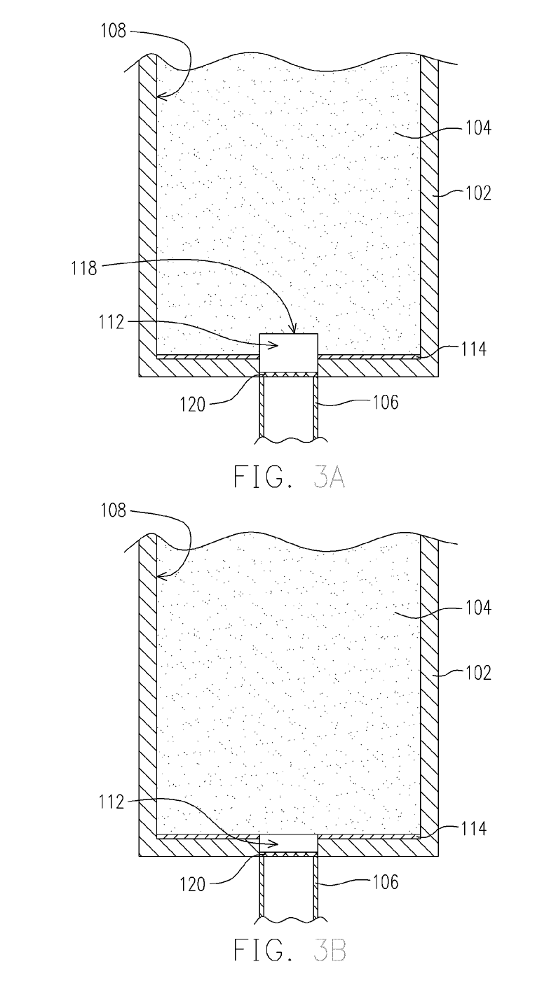

According to another embodiment of the present invention, a sheet 116 is further provided to be disposed between the ink storage unit 104 and the inner wall of the bottom of the housing 102 as shown in FIG. 2. The sheet 116 is, for example but not limited to, a plastic sheet. In this embodiment, adhesive layers 114 are respectively disposed between the ink storage unit 104 and the sheet 116, and between the sheet 116 and the inner wall of the bottom of the housing 102. The adhesive material and the adhering method are similar to those that have been described in FIG. 1 and will not be repeated again. In addition, the sheet 116 can be welded to the ink storage unit 104 on its upper surface and to the inner wall of the bottom of the housing 102 on its bottom surface by heat sealing or ultrasonic welding so that the ink storage unit 104 can contact indirectly with the inner wall of the bottom of the housing 102 through the sheet 116.

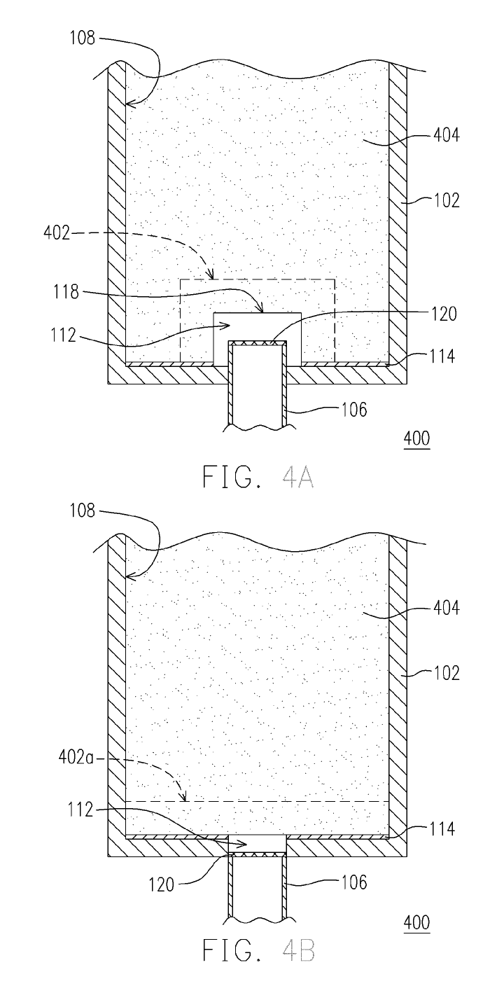

It is noted that the height of the ink pipe is not limited and should not be used to limit the scope of the present invention. For example, the ink pipe 106 can be extended into the sealed space 108. In other words, the top of the ink pipe 106 is higher than the inner wall of the bottom of the housing 102. In another embodiment, the top of the ink pipe 106 is lower than the inner wall of the bottom of the housing 102 as shown in FIG. 3A. However, the scope of the present invention is not limited to the above two embodiments. One skilled in the art can adjust the position of the ink pipe 106 depending on the practical application. When the top of the ink pipe 106 is lower than the inner wall of the bottom of the housing 102, the bottom of the ink storage unit 104 can have a cave 118 (as shown in FIG. 3A) or a plane surface(as shown in FIG. 3B).

In another embodiment, the ink storage unit of the ink cartridge has a non-uniform capillarity so that the ink can flow toward the ink pipe and hence the rate of ink usability can be enhanced. The following description and the accompanying figures will illustrate this embodiment.

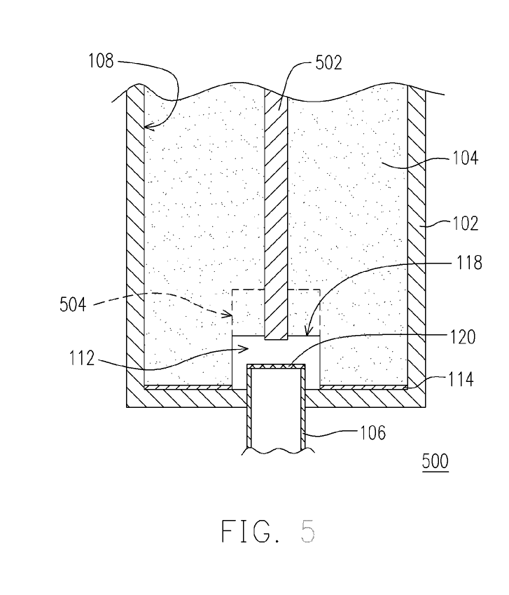

FIG. 4A is the cross-sectional view of an ink cartridge in accordance with another embodiment of the present invention. The difference between the ink cartridge 400 of FIG. 4A and the ink cartridge 100 of FIG.1 is the ink storage unit 404. To simply the illustration, except the ink storage unit 404, the elements in the ink cartridge 400 that are same as those in the ink cartridge 100 of FIG. 1 will not be described again hereinafter.

Referring to FIG. 4A, the ink storage unit 404 is disposed in the sealed space 108 and substantially airtightly contacts with the inner wall of the bottom of the sealed space 108 to reduce the chance of the bubbles around or within the ink pipe 106. The ink storage unit 404 adjacent to the ink pipe 106 (i.e., the ink storage unit 404 in the area 402) has a larger capillarity than the other portion of the ink storage unit 404 has so that the ink would flow toward the area 402 of the ink storage unit 404. When the ink in the area 402 of the ink storage unit 404 is substantially consumed, the ink storage unit 404 in the area 402 would absorb the ink outside the area 402 of the ink storage unit 404. Therefore, it can effectively reduce the ink residual and enhance the rate of ink usability.

The ink storage unit 404 of this embodiment is made of porous material such as foam or a sponge material or a fabric material. Taking FIG. 4A as an example, to make the ink storage unit 404 in the area 402 have a larger capillarity, before the ink storage unit 404 is disposed in the sealed space 108, a local heat pressure can apply to the ink storage unit 404 so that the ink storage unit 404 in the area 402 has a larger capillarity. Then the ink storage unit 404 is disposed in the sealed space 108.

On skilled in the art would know that when the bottom of the ink storage unit 404 is a plane surface (as shown in FIG. 4B), the heat pressure can apply to the bottom of the ink storage unit 404 so that the bottom surface and the area adjacent to the bottom surface of the ink storage unit 404 (the area 402a of the FIG. 4B) has a higher porous density, which has the similar effect of the area 402 of FIG. 4A. It is noted that the term of “local heat pressure” of this embodiment is not limited to apply the heat pressure on the cave 118 of the ink storage unit 404 in FIG. 4A, but also includes the case of applying the local heat pressure to the entire bottom of the ink storage unit 404 or a portion of the ink storage unit 404 adjacent to the ink pipe 106.

When the ink storage unit 404 is made of a sponge material or foam, the parameters of foaming process of the ink storage unit 404 can be controlled in a manner to fabricate the ink storage unit 404 with a non-uniform porous density such that the area 402 (or the area 402a in FIG. 4B) of the portion of the ink storage unit 404 adjacent to the ink pipe 106 has a larger porous density than the other portion of the ink storage unit 404.

Because it is possible to fabricate the ink storage unit with a localized larger porous density by controlling the process parameters of the foaming process or by heat-pressure, the problem of the capillarity in the compressed area of the ink storage unit being too strong due to the over compression of the ink storage unit caused by the ink pipe in the prior art can be effectively avoided.

It should be noted that other means of modifying the porous density of the ink storage unit may also be adapted to achieve the purpose of the present invention. The following embodiment will be used to further illustrate the present invention.

FIG. 5 is a cross-sectional view of the ink cartridge in accordance with another embodiment of the present invention. The ink cartridge 500 is similar to that described with reference to FIG. 1 except for an additional device disposed in the ink storage unit 104. Hence, detailed description of the other elements of the ink cartridge 500 that are similar to those of the ink storage unit 100 will not be repeated again hereinafter.

Referring to FIG. 5, the ink cartridge 500 includes a belt 502 inserted into the ink storage unit 104 above the ink pipe 106 to tighten the bottom of the ink storage unit 104 so that the ink storage unit 104 in the area 504 has a larger porous density. Hence, the capillarity in the area 504 can be increased to introduce the ink to flow toward the area 504 of the ink storage unit 104. The material of the belt 502 can be plastic material.

In this embodiment, the ink storage unit uses the belt 502 to tighten the bottom of the ink storage unit 104 to obtain the larger porosity density in a partial area, and the ink storage unit 104 in this embodiment is also bonded to the inner wall of the bottom of the housing 102. Hence, this embodiment can reduce the possibility of forming bubbles around the ink pipe 106 resulting from the ink pipe 106 being not entirely in contact with the ink storage unit 104 in the prior art.

In light of the above, according to embodiments of the present invention described above, air entering into the area between the ink pipe and the ink storage unit can be substantially reduced by letting the ink storage unit substantially airtightly contacts with the inner wall of the bottom of the housing. Therefore, the possibility of bubbles appearing in the ink pipe and/or on the filter of the ink pipe can be reduced and thereby the condition of blocking the ink pipe or filter can be avoided. Therefore, the ink can output from the cartridge to the chip smoothly.

In addition, an ink storage unit with a non-uniform porous density is disposed in the sealed space so that the ink flows toward the ink pipe under influence of the larger porous density of the portion of the ink storage unit. Hence, the ink can be effectively introduced into the ink pipe and thereby the rate of ink usability can be enhanced and the ink residual can be reduced.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. An ink cartridge, comprising:
a housing, having a substantially sealed space;
an ink pipe, connected to said housing, said ink pipe being fluidly linked to said sealed space; and
an ink storage unit, comprising a porous material, disposed inside said sealed space and substantially airtightly contacting with an inner wall of a bottom of said housing, said ink storage unit being above said ink pipe and having a gap with a top of said ink pipe.

2. The ink cartridge of claim 1, further comprising a filter disposed on said ink pipe.

3. The ink cartridge of claim 1, wherein said ink storage unit is adhered to the inner wall of the bottom of said housing.

4. The ink cartridge of claim 3, further comprising an adhesive layer for adhering said ink storage unit onto the inner wall of the bottom of said housing.

5. The ink cartridge of claim 1, wherein said ink storage unit is welded to the inner wall of the bottom of said housing.

6. The ink cartridge of claim 5, wherein said ink storage unit is welded to the inner wall of the bottom of said housing by heat sealing or ultrasound-welding.

7. The ink cartridge of claim 1, further comprising a sheet between said ink storage unit and the inner wall of the bottom of said housing, wherein said ink storage unit substantially airtightly contacts with said sheet and said sheet substantially airtightly contacts with the inner wall of the bottom of said housing.

8. The ink cartridge of claim 7, wherein said sheet is a plastic sheet.

9. The ink cartridge of claim 7, wherein said ink storage unit is adhered to said sheet and said sheet is adhered to the inner wall of the bottom of said housing.

10. The ink cartridge of claim 9, further comprising a first adhesive material between said ink storage unit and said sheet for adhering said ink storage unit onto said sheet, and a second adhesive material between said sheet and the inner wall of the bottom of said housing for adhering said sheet onto the inner wall of the bottom of said housing.

11. The ink cartridge of claim 7, wherein said ink storage unit is welded to said sheet and said sheet is welded to the inner wall of the bottom of said housing.

12. The ink cartridge of claim 11, wherein said ink storage unit is welded to said sheet by heat sealing or ultrasound welding, and said sheet is welded to the inner wall of the bottom of said housing by heat sealing or ultrasound welding.

13. The ink cartridge of claim 1, wherein said ink pipe is extended into said sealed space.

14. The ink cartridge of claim 1, wherein said porous material includes a sponge material or a fabric material.

15. The ink cartridge of claim 1, wherein said ink storage unit has a cave adjacent to said ink pipe.

16. The ink cartridge of claim 1, wherein before said ink storage unit is disposed inside said sealed space, a portion of said ink storage unit adjacent to said ink pipe is heat-pressed.

17. An ink cartridge, comprising:
a housing, having a substantially sealed space;
an ink pipe, connected to said housing, said ink pipe being fluidly connected through said sealed space; and
an ink storage unit, comprising a porous material, disposed inside said sealed space and substantially airtightly contacting with an inner wall of the bottom of said housing, a portion of said ink storage unit adjacent to said ink pipe having a capillarity larger than other portion of said ink storage unit, said ink storage unit being above said ink pipe and having a gap with a top of said ink pipe.

18. The ink cartridge of claim 17, wherein said ink storage unit has a uniform porous density before being treated with a heat pressing process and said portion of said ink storage unit adjacent to said ink pipe has a porous density larger than the other portion of said ink storage unit has after said heat pressing process.

19. The ink cartridge of claim 17, wherein said porous material includes a sponge material or a fabric material.

20. The ink cartridge of claim 19, wherein when said porous material is a sponge material, said ink storage unit is fabricated using a foaming process such that a porous density of a portion of said ink storage unit adjacent to said ink pipe is larger than other portion of said ink storage unit.

21. The ink cartridge of claim 17, further comprising a belt inserted into said ink storage unit to tighten the bottom of said ink storage unit such that a porosity density of a portion of said ink storage unit adjacent to said ink pipe larger than other portion of said ink storage unit.

22. The ink cartridge of claim 21, wherein the material of said belt includes a plastic material.

23. The ink cartridge of claim 17, further comprising a filter disposed on said ink pipe.

24. The ink cartridge of claim 17, wherein said ink storage unit is adhered to the inner wall of the bottom of said housing.

25. The ink cartridge of claim 24, further comprising an adhesive layer for adhering said ink storage unit onto the inner wall of the bottom of said housing.

26. The ink cartridge of claim 17, wherein said ink storage unit is welded to the inner wall of the bottom of said housing.

27. The ink cartridge of claim 26, wherein said ink storage unit is welded to the inner wall of the bottom of said housing by using heat sealing or ultrasound welding.

28. The ink cartridge of claim 17, further comprising a sheet between said ink storage unit and the inner wall of the bottom of said housing, wherein said ink storage unit substantially airtightly contacts with said sheet and said sheet substantially airtightly contacts with the inner wall of the bottom of said housing.

29. The ink cartridge of claim 28, wherein said sheet is a plastic sheet.

30. The ink cartridge of claim 28, wherein said ink storage unit is adhered to said sheet and said sheet is adhered to the inner wall of the bottom of said housing.

31. The ink cartridge of claim 30, further comprising a first adhesive layer between said ink storage unit and said sheet for adhering said ink storage unit onto said sheet, and a second adhesive layer between said sheet and the inner wall of the bottom of said housing for adhering said sheet onto the inner wall of the bottom of said housing.

32. The ink cartridge of claim 28, wherein said ink storage unit is welded to said sheet and said sheet is welded to the inner wall of the bottom of said housing.

33. The ink cartridge of claim 32, wherein said ink storage unit is welded to said sheet by heat sealing or ultrasound welding, and said sheet is welded to the inner wall of the bottom of said housing by heat sealing or ultrasound welding.

34. The ink cartridge of claim 17, wherein said ink pipe is extended into said sealed space.

35. The ink cartridge of claim 17, wherein said ink storage unit has a cave adjacent to said ink pipe.

36. The ink cartridge of claim 35, wherein a portion of said ink storage unit comprising said cave is local heat-pressed.

37. The ink cartridge of claim 17, wherein said portion of said ink storage unit adjacent to said ink pipe is heat-pressed.
